(19) United States
(12) Patent Application Publication
(10) Pub. No.: US 2008/0196488 A1
(43) Pub. Date: Aug. 21, 2008

(54) Method and Device for Determining the Ratio Between the Fuel Mass Burned in a Cylinder of an Internal Combustion Engine and the Fuel Mass Supplied to the Cylinder

(76) Inventors: Erwin Bauer, Lappersdorf (DE); Dietmar Ellmer, Regensburg (DE); Thorsten Lauer, Holzheim a. Forst (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/913,835

(22) PCT Filed: May 10, 2006
(86) PCT No.: PCT/EP2006/062193

§ 371 Date: Nov. 7, 2007

(30) Foreign Application Priority Data
May 10, 2005 (DE) 10 2005 021 528.9

(51) Int. Cl. G01M 15/04; G01M 15/08

(52) U.S. Cl. 73/114.53; 73/114.18

(57) ABSTRACT

The isentropic exponent (χ) and the constant (k) in the equation p·V^{χ}=k for processes before and after fuel combustion in the cylinder are determined on the basis of the signals from a cylinder pressure sensor and from a crankshaft sensor. Cylinder pressures (p) before and after fuel combustion can be determined through the equation with the corresponding isentropic exponents (χ) and corresponding constants. During fuel combustion, cylinder pressure (p) is sensed by the cylinder pressure sensor. The ratio between the fuel mass burned in the cylinder of the internal combustion engine and the fuel mass (MBR) supplied to the cylinder is determined on the basis of the above-mentioned variables. The process has the advantage of reducing the computation outlay necessary to determine the ratio between the fuel mass burned in the cylinder of the internal combustion engine and the fuel mass (MBR) supplied to the cylinder.

### CROSS-REFERENCE TO RELATED APPLICATION

This application is a U.S. national stage application of International Application No. PCT/EP2006/062193 filed May 10, 2006, which designates the United States of America, and claims priority to German application number 10 2005 021 528.9 filed May 10, 2005, the contents of which are hereby incorporated by reference in their entirety.

### TECHNICAL FIELD

The present invention relates to a method and a device for determining with the aid of a cylinder pressure sensor the ratio between the fuel mass burned in a cylinder of an internal combustion engine and the fuel mass supplied to the cylinder.

### BACKGROUND

The combustion function constitutes an important variable for describing and controlling the combustion process taking place inside cylinders of internal combustion engines. The combustion function is formed from the ratio of burned to supplied fuel mass (MBR (mass burn rate)) as a function of the crank angle. From the combustion function, a further variable that is characteristic of the combustion process can be obtained in the combustion concentration point. The combustion concentration point marks the operating point of the combustion function at which 50% of the fuel mass supplied is burned. The efficiency and the acoustic and emissions behavior of an internal combustion engine are essentially determined by the combustion function. A prerequisite for determining the combustion function is knowledge of the cylinder pressure as a function of the crank angle. With knowledge of this dependency and with the aid of pressure trace analysis and working-process calculation, the MBR and thus the combustion function can be computed using thermodynamic models of combustion processes.

Further details regarding thermodynamic models of combustion processes can be found in “Handbuch Verbrennungsmotor” [Internal combustion engine manual], by Richard van Basshuysen/Fred Schafer, 1^{st} edition, April 2002, chapters 5.2 and 5.3 and in “Kraftfahrtechnisches Taschenbuch” [Automotive engineering pocket book] from Bosch, 22^{nd} edition, September 1995, pages 358 to 363.

In determining the MBR and the combustion function using thermodynamic models the problem arises that the computational operations required are very complex and high scanning frequencies for signals from a cylinder pressure sensor and a crankshaft sensor are needed. As a result, determination of the MBR and of the combustion function can be realized in engine control units only at very high cost. Furthermore, despite the high costs, they can often not be determined in real time.

DE 102 37 328 A1 discloses a method for regulating the combustion process of an internal combustion engine which can be operated at least in certain operating states with controlled auto-ignition (HCCI mode (homogeneous charge compression ignition mode). The combustion process in HCCI mode is modeled here on the basis of cyclical processes, the combustion process being described with the aid of internal status variables such as e.g. combustion curve, pressure curve, temperature curve or the combustion concentration point. The output variables such as e.g. the signal from a knock sensor, the exhaust gas temperature or the air/fuel ratio, of the modeled and of the real combustion process are fed to a regulator which regulates the control variables influencing the combustion process such as e.g. the fuel injection or exhaust gas recirculation.

### SUMMARY

The ratio between the fuel mass burned in a cylinder of an internal combustion engine and the fuel mass supplied to the cylinder can be determined with little computational outlay, according to an embodiment of a method and means for determining the ratio between the fuel mass burned in a cylinder of an internal combustion engine and the fuel mass supplied to the cylinder, in which the cylinder volume is derived by a crankshaft sensor associated with a crankshaft and the cylinder pressure is measured by a cylinder pressure sensor associated with the cylinder, wherein the method comprises the steps of and the means are operable to: determining a first isentropic exponent and a first constant from a first plurality of value pairs of cylinder volume and associated cylinder pressure for the process before fuel combustion in the cylinder,—for an operating point at which the ratio between the fuel mass burned in the cylinder and the fuel mass supplied to the cylinder is to be determined, determining a first cylinder pressure for the process before fuel combustion using the first isentropic exponent and the first constant,—during fuel combustion in the cylinder, recording a second cylinder pressure measured by the cylinder pressure sensor for the operating point,—determining a second isentropic exponent and a second constant from a second plurality of value pairs of cylinder volume and associated cylinder pressure for the process after fuel combustion in the cylinder,—for the operating point, determining a third cylinder pressure for the process after fuel combustion using the second isentropic exponent and the second constant, and—determining the ratio between the fuel mass burned in the cylinder and the fuel mass supplied to the cylinder for the operating point using the first, second, and third cylinder pressures before, during, and after fuel combustion. According to a further embodiment, the ratio between the fuel mass burned in the cylinder and the fuel mass supplied to the cylinder can be determined for a plurality of operating points and the combustion function is determined from the results.

According to a further embodiment, a combustion concentration point can be determined by means of the combustion function. According to a further embodiment, the first isentropic exponent (χᵥ) and the first constant (kᵥ) for the process before fuel combustion in the cylinder can be determined on the basis of the following equation:

p·V^{χ}^{ₓ}=kᵥ

and the second isentropic exponent (χₙ) and the second constant (kₙ) for the process after fuel combustion in the cylinder on the basis of the following equation:

p·V^{χ}^{ₘ}=kₙ.

According to a further embodiment, the first or second isentropic exponent (χ) for the process before fuel combustion in the cylinder and/or for the process after fuel combustion in the cylinder can be determined by means of the following equation:

$$χ = \frac{1 n \frac{{p}_{2}}{{p}_{1}}}{1 n \frac{{V}_{1}}{{V}_{2}}} ,$$

where χ designates the respective isentropic exponent, p₁ and p₂ measured values of the cylinder pressure sensor and V₁ and V₂ the associated cylinder pressure volumes. According to a further embodiment, the ratio between the fuel mass burned in the cylinder and the fuel mass supplied to the cylinder can be determined by means of the following equation:

$$MBR = c \cdot \frac{{P}_{w} - {P}_{v}}{{P}_{n} - {P}_{v}} \cdot 100 \% ,$$

where χ designates a constant. According to a further embodiment, if more than two value pairs for the cylinder volume and the associated cylinder pressure are available, a mean value of the respective isentropic exponent can be determined and this mean value can be used to determine the cylinder pressure before or after fuel combustion in the cylinder. According to a further embodiment, if more than two value pairs for the cylinder volume and the associated cylinder pressure are available, a mean value of the respective constant can be determined and this mean value can be used to determine the cylinder pressure before or after fuel combustion in the cylinder. According to a further embodiment, internal combustion engine control variables influencing the combustion process can be changed as a function of the ratio between the fuel mass burned in the cylinder and the fuel mass supplied to the cylinder. According to a further embodiment, a comparison can be carried out between the ratio between the fuel mass burned in the cylinder and the fuel mass supplied to the cylinder and the ratio between the fuel mass burned in the cylinder and the fuel mass supplied to the cylinder determined from an engine characteristics map stored in a control unit and internal combustion engine control variables influencing the combustion process can be changed depending on the result of the comparison. According to a further embodiment, the method can be applied in internal combustion engines which can be operated at least in certain operating states with controlled auto-ignition. According to a further embodiment, the ratio between the fuel mass burned in the cylinder and the fuel mass supplied to the cylinder or the combustion function or the combustion concentration point can be determined for a plurality of cylinders of the internal combustion engine. According to a further embodiment, in a control unit a scanning frequency for the recording of signals from the cylinder pressure sensor or for the recording of signals from the crankshaft sensor can be changed as a function of the ratio between the fuel mass burned in the cylinder and the fuel mass supplied to the cylinder.

### BRIEF DESCRIPTION OF THE DRAWINGS

Exemplary embodiments of the invention will be clarified below with reference to the schematic drawings, in which:

FIG. 1 shows a schematic representation of a device for implementing the method according to an embodiment and

FIG. 2 shows a flow diagram for illustrating the method according to an embodiment.

### DETAILED DESCRIPTION

According to various embodiments, a method and a corresponding device are operable to determine with the aid of a cylinder pressure sensor the ratio between the fuel mass burned in a cylinder of an internal combustion engine and the fuel mass supplied to the cylinder. For this purpose, an isentropic exponent χᵥ and a constant kᵥ are determined from a plurality of value pairs of cylinder volume V and associated cylinder pressure p for the process before fuel combustion in the cylinder. Here, the cylinder volume is determined from the signal of a crankshaft sensor associated with a crankshaft and the cylinder pressure by means of the signal from the cylinder pressure signal.

After the two variables χᵥ and kᵥ have been determined, the cylinder pressure for the process before fuel combustion in the cylinder is determined on the basis of the variables χᵥ and kᵥ for the operating point at which the ratio between the fuel mass burned in the cylinder and the fuel mass supplied to the cylinder is to be determined.

Subsequently, the measured value from the cylinder pressure sensor is recorded during fuel combustion in the cylinder for the above-mentioned operating point. Thereafter, an isentropic exponent χₙ and a constant kₙ are determined from a plurality of value pairs of cylinder volume and associated cylinder pressure for the process after fuel combustion in the cylinder, in a manner analogous to that for the process before fuel combustion in the cylinder.

After the two variables χₙ and kₙ have been determined, the cylinder pressure for the process after fuel combustion in the cylinder is determined on the basis of the variables χₙ and kₙ for the operating point at which the ratio between the fuel mass burned in the cylinder and the fuel mass supplied to the cylinder is to be determined.

Subsequently, with the aid of the above-determined cylinder pressures before, during and after fuel combustion, the ratio between the fuel mass burned in the cylinder and the fuel mass supplied to the cylinder is determined for the above-mentioned operating point.

The method allows the ratio between the fuel mass burned in the cylinder and the fuel mass supplied to the cylinder to be determined for any operating points, although the method needs only few value pairs for the cylinder volumes and associated cylinder pressures (a minimum of four) on the basis of metrologically recorded signals from the cylinder pressure sensor and crankshaft sensor. The method according to an embodiment has the advantage that no costly thermodynamic models are used and the computational outlay is thus low as a result. In this way, the ratio between the fuel mass burned in the cylinder and the fuel mass supplied to the cylinder can be determined in an engine control unit in real time without increasing expenditure due to increased demands on the hardware deployed in engine control units.

The method according to an embodiment is applicable to four-stroke petrol engines and diesel engines as well as to gas-operated engines.

According to an embodiment, the combustion function is formed from the ratio determined for a plurality of operating points between the fuel mass burned in the cylinder and the fuel mass supplied to the cylinder. The combustion function can be used to regulate the combustion process of internal combustion engines. The efficiency and acoustic and emissions behavior of an internal combustion engine can be optimized in this way.

According to an embodiment, the combustion concentration point is determined from the combustion function. The combustion concentration point constitutes a characteristic variable for describing the combustion process of internal combustion engines and can be used for regulating the combustion process. The efficiency and acoustic and emissions behavior of an internal combustion engine can be optimized in this way.

According to an embodiment, the isentropic exponent χᵥ and the constant kᵥ are determined for the process before fuel combustion in the cylinder on the basis of the following equation:

p·V^{χ}^{ᵥ}=k (Equation 1),

where the p designates the cylinder pressure and V the cylinder volume. For the process after the combustion (index n) of fuel in the cylinder, the isentropic exponent χₙ and the constant kₙ are determined on the basis of the following equation:

p·V^{χ}^{ₙ}=kₙ (Equation 2).

Equation 1 and equation 2 enable determination of the respective isentropic exponent and of the respective constant with little computational outlay.

According to an embodiment, the isentropic exponent for the process before fuel combustion in the cylinder or the isentropic exponent for the process after fuel combustion in the cylinder is determined by means of the following equation:

$$χ = \frac{1 n \frac{{p}_{2}}{{p}_{1}}}{1 n \frac{{V}_{1}}{{V}_{2}}} . \qquad ( Equation 3 )$$

In equation 3, p₁ and p₂ designate measured values of the cylinder pressure sensor and V₁ and V₂ the associated cylinder pressure volumes which are determined on the basis of the signals from the crankshaft sensor. Equation 3 enables determination of the respective isentropic exponent χ with little computational outlay.

According to an embodiment, the ratio between the fuel mass burned in the cylinder and the fuel mass supplied to the cylinder (MBR) is determined on the basis of the following equation:

$$MBR = c \cdot \frac{{P}_{w} - {P}_{v}}{{P}_{n} - {P}_{v}} \cdot 100 \% . \qquad ( Equation 4 )$$

In equation 4, MBR designates the ratio between the fuel mass burned in the cylinder and the fuel mass supplied to the cylinder, c a constant, p_{w} the measured value of the cylinder pressure sensor during fuel combustion in the cylinder, pᵥ the cylinder pressure, determined by means of equation 1, before fuel combustion in the cylinder and pₙ the cylinder pressure, determined by means of equation 2, after the combustion of fuel in the cylinder. The computational outlay required for determining the ratio between the fuel mass burned in the cylinder and the fuel mass supplied to the cylinder in accordance with Equation 4 is low. Consequently, only a relatively limited storage requirement and limited computing power are needed for their determination. According to an embodiment, where more than two value pairs for the cylinder volume and the associated cylinder pressure are available, a mean value of the isentropic exponent is determined. This mean value is used in the corresponding equation 1 or 2 for determining the cylinder pressure before or after fuel combustion in the cylinder. The use of a mean value reduces the influence of individual measurement errors when recording measured values from the crankshaft sensor or the cylinder pressure sensor on the determination of cylinder pressures by means of Equation 1 or 2.

According to an embodiment, where more than two value pairs for the cylinder volume and the associated cylinder pressure are available, a mean value of the constants specified in Equation 1 or 2 is determined. This mean value is used in the corresponding equation 1 or 2 for determining the cylinder pressure before or after fuel combustion in the cylinder. The use of a mean value reduces the influence of individual measurement errors when recording measured values from the crankshaft sensor or the cylinder pressure sensor on the determination of the cylinder pressures by means of Equation 1 or 2.

According to an embodiment, internal combustion engine control variables influencing the combustion process, such as e.g. quantity of fuel to be injected or ignition time, are changed as a function of the ratio between the fuel mass burned in the cylinder and the fuel mass supplied to the cylinder. By this means, the combustion process can be optimized with regard to fuel consumption, acoustic behavior and pollutant emissions.

According to an embodiment, a comparison is carried out between the ratio determined according to the method between the fuel mass burned in the cylinder and the fuel mass supplied to the cylinder and the ratio determined from an engine characteristics map stored in a control unit between the fuel mass burned in the cylinder and the fuel mass supplied to the cylinder. The result of this comparison is fed to a regulator which determines internal combustion engine control variables influencing the combustion process such as e.g. quantity of fuel to be injected or ignition time. By this means, the combustion process can be optimized with regard to fuel consumption, acoustic behavior and pollutant emissions.

According to an embodiment, the method is applied in internal combustion engines which can be operated at least in certain operating states with controlled auto-ignition (HCCI mode). Regulation of the combustion process of these internal combustion engines can be optimized by this means.

According to an embodiment, the ratio between the fuel mass burned in the cylinder and the fuel mass supplied to the cylinder or the combustion function or the combustion concentration point is determined for a plurality of cylinders of an internal combustion engine. This enables optimal regulation of the combustion processes taking place in the respective cylinders. Tolerances between the cylinders, caused by production or ageing, can be compensated for by this means.

According to an embodiment, in a control unit the scanning frequency for recording the signals from the cylinder pressure sensor or for recording the signals from the crankshaft sensor is changed depending on the result determined in accordance with the method for the ratio between the fuel mass burned in the cylinder and the fuel mass supplied to the cylinder. By this means, combustion processes in the cylinder can, given appropriate results, be recorded with increased temporal resolution and regulation of the combustion process can thus be optimized.

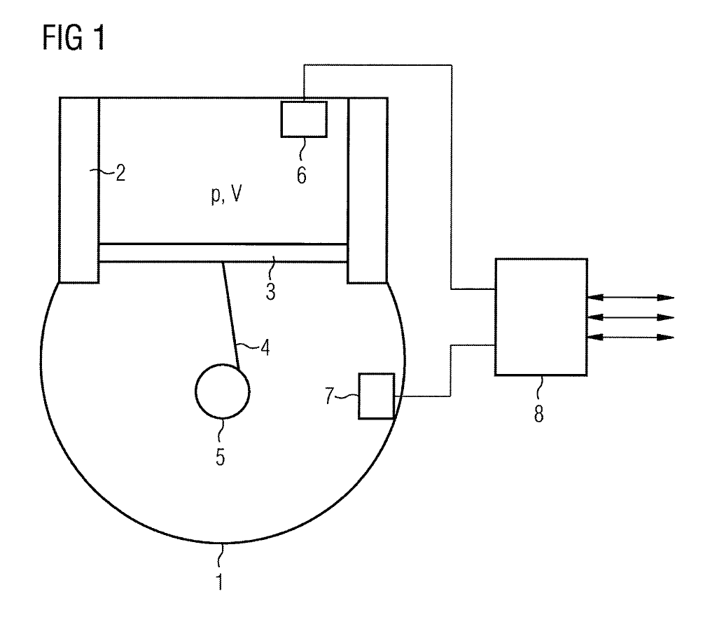

FIG. 1 shows the schematic representation of a device for implementing the method according to an embodiment. The device has an engine block 1, which comprises a cylinder 2. Inside the cylinder 2 there is located a piston 3, which is connected via a connecting rod 4 to a crankshaft 5. By means of a combustion process taking place in the cylinder 2, the piston 3 executes a translatory movement in a vertical direction. The cylinder volume and the cylinder pressure are dependent on the position of the piston 3 in the cylinder 2. For the sake clarity of the diagram, other components required for the proper functioning of an internal combustion engine such as e.g. inlet and outlet valves, spark plugs, an intake manifold or an exhaust manifold are not included in the drawing. A cylinder pressure sensor 6 for recording the cylinder pressure is located inside the cylinder 2. Furthermore, a crankshaft sensor 7 for recording the crank angle is located inside the engine block 1. The signals of both sensors are recorded by a control unit 8. In the control unit 8, the ratio between the fuel mass burned in a cylinder 2 of the internal combustion engine and the fuel mass supplied to the cylinder 2 is determined according to various embodiments by means of the signals from the two sensors and other information available in the control unit, such as e.g. rotational speed of the internal combustion engine. Arrows located to the right of the control unit 8 make it clear that the control unit 8 can process signals from further sensors or that exchanging data with further control units is possible. Furthermore, internal combustion engine control variables influencing the combustion process can be changed as a function of the ratio between the fuel mass burned in the cylinder 2 and the fuel mass supplied to the cylinder 2 and corresponding actuating signals transmitted from the control unit 8 to corresponding final control elements. An engine control unit, for example, can be used as a control unit 8.

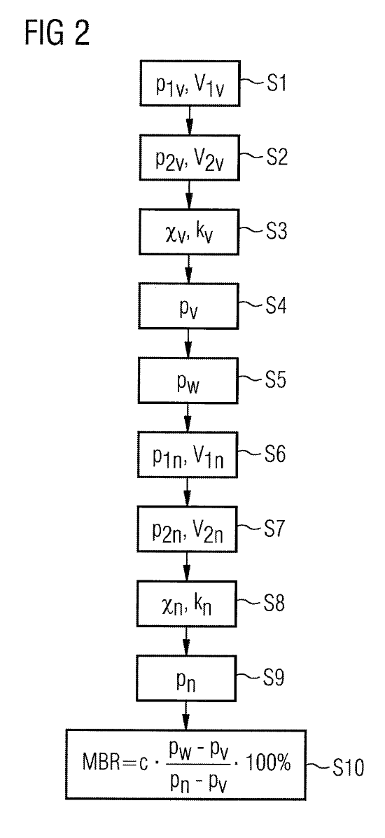

FIG. 2 shows a flow diagram for illustrating the method according to an embodiment. In step S1, the measured values of the crankshaft sensor 7 and the cylinder pressure sensor 6 are recorded for the process before fuel combustion in the cylinder 2 and a value pair for the cylinder volume V₁ᵥ and the associated cylinder pressure P₁ᵥ determined herefrom. In step S2, the measured values of the crankshaft sensor 7 and the cylinder pressure sensor 6 are recorded for a different time before fuel combustion in the cylinder 2 and a further value pair for the cylinder volume V₂ᵥ and the associated cylinder pressure P₂ᵥ determined herefrom. In step S3, the isentropic exponent χᵥ and the constant kᵥ in Equation 1 are determined for the process before fuel combustion in the cylinder 2 by means of the value pairs determined in steps S1 and S2. The isentropic exponent χᵥ is determined by means of the following equation:

$$χ = \frac{ln \frac{{p}_{2 v}}{{p}_{1 v}}}{ln \frac{{V}_{1 v}}{{V}_{2 v}}} . \qquad ( Equation 5 )$$

The constant kᵥ is determined on the basis of these variables:

p₁ᵥ·V₁ᵥ^{χ}^{ᵥ}=kᵥ (Equation 6).

After the isentropic exponent χᵥ and the constant kᵥ have been determined, the cylinder pressure pᵥ for every operating point before fuel combustion in the cylinder 2 can be determined by means of Equation 1. Subsequently, in step S4, the cylinder pressure pᵥ before fuel combustion in the cylinder 2 is determined by means of Equation 1 for a selected operating point. In step S5, the measured value p_{w} of the cylinder pressure sensor 6 is recorded for the above-mentioned operating point.

Subsequently, in step S6, the measured values of the crankshaft sensor 7 and of the cylinder pressure sensor 6 are recorded for the process after fuel combustion in the cylinder 2 and a value pair for the cylinder volume V₁ₙ and the associated cylinder pressure P₁ₙ determined herefrom. In step S7, the measured values of the crankshaft sensor 7 and of the cylinder pressure sensor 6 are recorded for another point in time after fuel combustion in the cylinder 2 and a further value pair for the cylinder volume V₂ₙ and the associated cylinder pressure p₂ₙ determined herefrom. In step S8, the isentropic exponent χₙ and the constant k, in Equation 2 are determined for the process before fuel combustion in the cylinder 2 by means of the value pairs determined in steps S6 and S7. The isentropic exponent χₙ is determined by means of the following equation:

$$χ = \frac{1 n \frac{{P}_{2 n}}{{P}_{1 n}}}{1 n \frac{{V}_{1 n}}{{V}_{2 n}}} . \qquad ( Equation 7 )$$

The constant kₙ is determined on the basis of the following equation:

p₁ₙ·V₁ₙ^{χ}^{ₙ}=kₙ (Equation 8).

After the isentropic exponent χₙ and the constant kₙ have been determined, the cylinder pressure pₙ can be determined by means of Equation 2 for each operating point after fuel combustion in the cylinder 2. Subsequently, in step S9, the cylinder pressure pₙ after fuel combustion in the cylinder 2 is determined by means of Equation 2 for the above-mentioned operating point. In step S10, the ratio between the fuel mass burned in the cylinder 2 of the internal combustion engine and the fuel mass supplied to the cylinder 2 MBR is determined by means of Equation 4. In Equation 4, c designates a constant.

What is claimed is:

1. A method for determining the ratio between the fuel mass burned in a cylinder of an internal combustion engine and the fuel mass supplied to the cylinder, in which the cylinder volume is derived by a crankshaft sensor associated with a crankshaft and the cylinder pressure is measured by a cylinder pressure sensor associated with the cylinder, the method comprising the steps of:
determining a first isentropic exponent and a first constant from a first plurality of value pairs of cylinder volume and associated cylinder pressure for the process before fuel combustion in the cylinder,
for an operating point at which the ratio between the fuel mass burned in the cylinder and the fuel mass supplied to the cylinder is to be determined, determining a first cylinder pressure for the process before fuel combustion using the first isentropic exponent and the first constant,
during fuel combustion in the cylinder, recording a second cylinder pressure measured by the cylinder pressure sensor for the operating point,
determining a second isentropic exponent and a second constant from a second plurality of value pairs of cylinder volume and associated cylinder pressure for the process after fuel combustion in the cylinder,
for the operating point, determining a third cylinder pressure for the process after fuel combustion using the second isentropic exponent and the second constant, and
determining the ratio between the fuel mass burned in the cylinder and the fuel mass supplied to the cylinder for the operating second, and third cylinder pressures before, during, and after fuel combustion.

2. The method according to claim 1, wherein the ratio between the fuel mass burned in the cylinder and the fuel mass supplied to the cylinder is determined for a plurality of operating points and the combustion function is determined from the results.

3. The method according to claim 2, wherein a combustion concentration point is determined by means of the combustion function.

4. The method according to claim 1, wherein the first isentropic exponent (χᵥ) and the first constant (kᵥ) for the process before fuel combustion in the cylinder are determined on the basis of the following equation:
p·V^{χ}^{ᵥ}=kᵥ
and the second isentropic exponent (χₙ) and the second constant (kₙ) for the process after fuel combustion in the cylinder on the basis of the following equation:
p·V^{χ}^{ₙ}=kₙ.

5. The method according to claim 4, wherein the first or second isentropic exponent (χ) for the process before fuel combustion in the cylinder and/or for the process after fuel combustion in the cylinder are determined by means of the following equation:
$$χ = \frac{1 n \frac{{p}_{2}}{{p}_{1}}}{1 n \frac{{V}_{1}}{{V}_{2}}} ,$$
where χ designates the respective isentropic exponent, p₁ and p₂ measured values of the cylinder pressure sensor and V₁ and V₂ the associated cylinder pressure volumes.

6. The method as according to claim 1, wherein the ratio between the fuel mass burned in the cylinder and the fuel mass supplied to the cylinder is determined by means of the following equation:
$$MBR = c \cdot \frac{{P}_{w} - {P}_{v}}{{P}_{n} - {P}_{v}} \cdot 100 \% ,$$
where c designates a constant.

7. The method according to claim 1, wherein if more than two value pairs for the cylinder volume and the associated cylinder pressure are available, a mean value of the respective isentropic exponent is determined and this mean value is used to determine the cylinder pressure before or after fuel combustion in the cylinder.

8. The method according to claim 1, wherein if more than two value pairs for the cylinder volume and the associated cylinder pressure are available, a mean value of the respective constant is determined and this mean value is used to determine the cylinder pressure before or after fuel combustion in the cylinder.

9. The method according to claim 1, wherein internal combustion engine control variables influencing the combustion process are changed as a function of the ratio between the fuel mass burned in the cylinder and the fuel mass supplied to the cylinder.

10. The method according to claim 1, wherein a comparison is carried out between the ratio between the fuel mass burned in the cylinder and the fuel mass supplied to the cylinder and the ratio between the fuel mass burned in the cylinder and the fuel mass supplied to the cylinder determined from an engine characteristics map stored in a control unit and internal combustion engine control variables influencing the combustion process are changed depending on the result of the comparison.

11. The method according to claim 1, wherein the method is applied in internal combustion engines which can be operated at least in certain operating states with controlled auto-ignition.

12. The method according to claim 1, wherein the ratio between the fuel mass burned in the cylinder and the fuel mass supplied to the cylinder or the combustion function or the combustion concentration point is determined for a plurality of cylinders of the internal combustion engine.

13. The method according claim 1, wherein in a control unit a scanning frequency for the recording of signals from the cylinder pressure sensor or for the recording of signals from the crankshaft sensor is changed as a function of the ratio between the fuel mass burned in the cylinder and the fuel mass supplied to the cylinder.

14. A device for determining the ratio between the fuel mass burned in a cylinder of an internal combustion engine and the fuel mass supplied to the cylinder, in which the cylinder volume is derived by a crankshaft sensor associated with a crankshaft and the cylinder pressure is measured by a cylinder pressure sensor associated with the cylinder, comprising:
means for determining a first isentropic exponent and a first constant from a plurality of first value pairs of cylinder volume and associated cylinder pressure for the process before fuel combustion in the cylinder,
for an operating point at which the ratio between the fuel mass burned in the cylinder and the fuel mass supplied to the cylinder is to be determined, means for determining a first cylinder pressure for the process before fuel combustion isentropic exponent and the first constant,
during fuel combustion in the cylinder, means for recording a second cylinder pressure measured by the cylinder pressure sensor for the operating point,
means for determining a second isentropic exponent and a second constant from a plurality of second value pairs of cylinder volume and associated cylinder pressure for the process after fuel combustion in the cylinder,
for the operating point, means for determining a third cylinder pressure for the process after fuel combustion using the second isentropic exponent and the second constant,
means for determining the ratio between the fuel mass burned in the cylinder and the fuel mass supplied to the cylinder for the operating point using the first, second, and third cylinder pressures before, during, and after fuel combustion.

15. The device according to claim 14, wherein if more than two value pairs for the cylinder volume and the associated cylinder pressure are available, means for determining a mean value of the respective isentropic exponent and for using the mean value to determine the cylinder pressure before or after fuel combustion in the cylinder.

16. The device according to claim 14, wherein if more than two value pairs for the cylinder volume and the associated cylinder pressure are available, means for determining a mean value of the respective constant and for using this mean value to determine the cylinder pressure before or after fuel combustion in the cylinder.

17. The device according to claim 14, comprising means for changing internal combustion engine control variables influencing the combustion process as a function of the ratio between the fuel mass burned in the cylinder and the fuel mass supplied to the cylinder.

18. The device according to claim 14, comprising a comparator for comparing the ratio between the fuel mass burned in the cylinder and the fuel mass supplied to the cylinder and the ratio between the fuel mass burned in the cylinder and the fuel mass supplied to the cylinder determined from an engine characteristics map stored in a control unit and internal combustion engine control variables influencing the combustion process are changed depending on the result of the comparison.

19. The device according to claim 14, wherein the ratio between the fuel mass burned in the cylinder and the fuel mass supplied to the cylinder or the combustion function or the combustion concentration point is determined for a plurality of cylinders of the internal combustion engine.

20. The device according to claim 14, further comprising a control unit in which a scanning frequency for the recording of signals from the cylinder pressure sensor or for the recording of signals from the crankshaft sensor is changed as a function of the ratio between the fuel mass burned in the cylinder and the fuel mass supplied to the cylinder.
